(19) United States
(12) Patent Application Publication
(10) Pub. No.: US 2006/0097692 A1
(43) Pub. Date: May 11, 2006

(54) Charger

(75) Inventors: Rei-Chung Chen, Shulin City (TW); Hsu-Pin Chien, Shulin City (TW); Huel-Lin Lai, Shulin City (TW)

Correspondence Address: TROXELL LAW OFFICE PLLC, SUITE 1404, 5205 LEESBURG PIKE, FALLS CHURCH, VA, 22041, US

(73) Assignee: L & K Precision Technology Co., Ltd.

(21) Appl. No.: 10/981,448

(22) Filed: Nov. 5, 2004

(51) Int. Cl. H02J 7/00

(52) U.S. Cl. 320/107

(57) ABSTRACT

A charger includes a first housing, a second housing connected with the first housing, and a PCB assembled between the first and second housings. The first housing is defined with a plurality of battery chambers. Each battery chamber is assembled with first and second resilient plates for respectively contacting positive and negative poles of a rechargeable battery. Each resilient plate has a contact portion and a soldering portion. A circuit system is defined at the PCB and includes an AC-DC circuit, a charging circuit, and a power output and input circuit. The circuits are connected with each other and connected with the soldering portions of the first and second resilient plates of each battery chamber. A power input socket and a power output socket are formed to connect with the power output and input circuit. Accordingly, the charger of the present invention can not only charge a rechargeable battery, but also directly supply power to an electrical device through an external power wire connected between the charger and the electrical device whereby the charger is convenient in use.

### BACKGROUND OF THE INVENTION

1. Field of the Invention

The present invention relates to a charger, and particularly to a charger which can charge a rechargeable battery through an indoor socket or a car cigarette socket whereby the charger can supply power to a mobile phone or the rechargeable battery can be directly installed in an electrical device such as an electrically operated toy, a remote controller, an electric torch and so on after the charge is finished.

2. Prior Art

As it is well known, a rechargeable electrical device is supplied with power generally in two manners, that's replacing a battery or charging the battery. It is convenient to replace the battery after it is used up. However, it is uneconomical to replace the battery. Therefore a common electrical device provides not only function of direct power supply, but also function of power supply through a rechargeable battery for repeated use and economical efficiency. The rechargeable battery can be charged through the electrical device using the rechargeable battery or a charger. However, the rechargeable battery can only be charged in doors, which is inconvenient in use.

Furthermore, the mobile phone is used so widely that one person almost has one mobile phone. Power supply to the mobile phone is extremely concerned to consumers. However, due to the different design style and specification of different brands of mobile phones, the rechargeable battery cannot be used in other mobile phone with different brand, which results in inconvenience of power supply.

### SUMMARY OF THE INVENTION

Accordingly, an object of the present invention is to provide a charger, which can not only charge a rechargeable battery, but also directly supply power to an electrical device through an external power wire connected between the charger and the electrical device whereby the charger is convenient in use.

A further object of the present invention is to provide a charger, which can charge a rechargeable battery through an indoor socket or a car cigarette socket whereby the charger is not limited to charge in doors.

To achieve the above-mentioned objects, a charger in accordance with the present invention includes a first housing, a second housing connected with the first housing, and a PCB assembled between the first and second housings. The first housing is defined with a plurality of battery chambers. Each battery chamber is assembled with first and second resilient plates for respectively contacting positive and negative poles of a rechargeable battery. Each resilient plate has a contact portion and a soldering portion. A circuit system is defined at the PCB and includes an AC-DC circuit, a charging circuit, and a power output and input circuit. The circuits are connected with each other and connected with the soldering portions of the first and second resilient plates of each battery chamber. A power input socket and a power output socket are formed to connect with the power output and input circuit.

Other objects, advantages and novel features of the present invention will be drawn from the following detailed embodiment of the present invention with attached drawings, in which:

### BRIEF DESCRIPTION OF THE DRAWINGS

FIG. 1 is an exploded view of a charger of the present invention;

FIG. 2 is an assembled view of FIG. 1;

FIG. 3 is a partial cross-sectional view showing the charger being at a charging state;

FIG. 4 is similar to FIG. 3 but showing a rechargeable battery being misconnected and so being unconnected to the charger; and

FIG. 5 is a flow chart of the charger of the present invention.

### DESCRIPTION OF THE PREFERRED EMBODIMENT

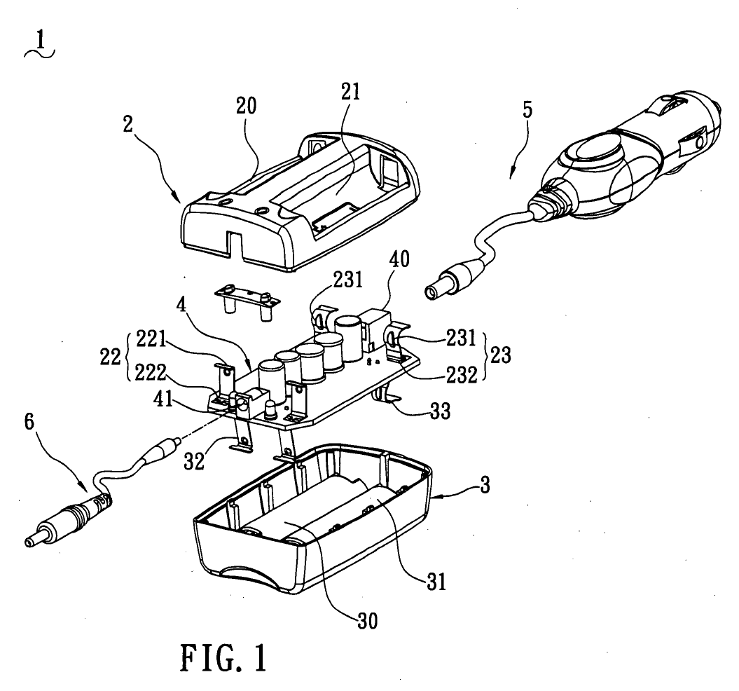

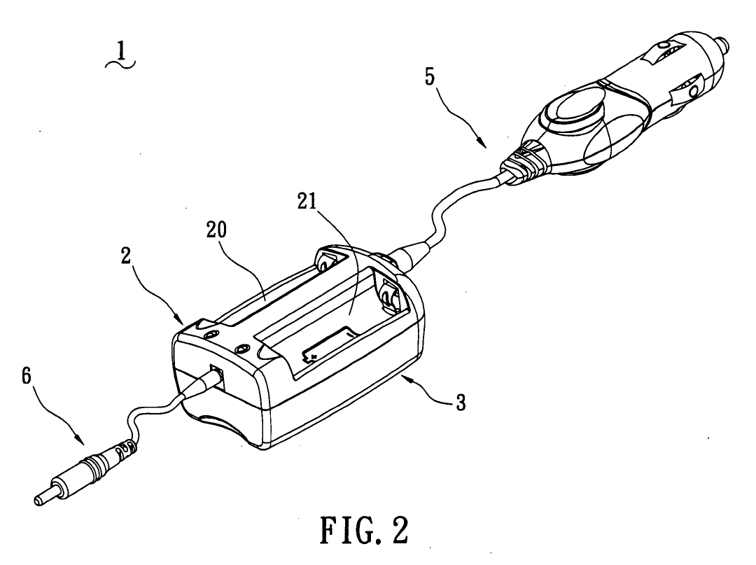

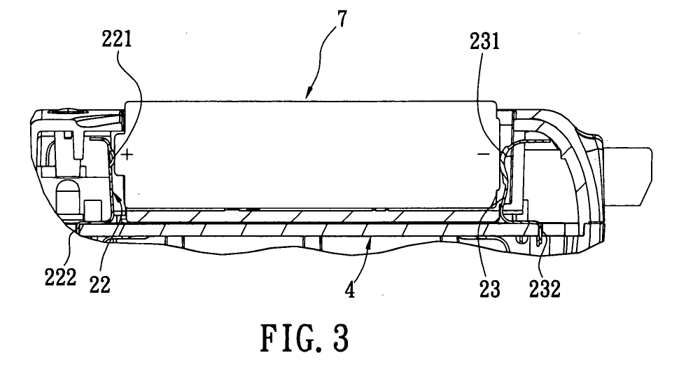

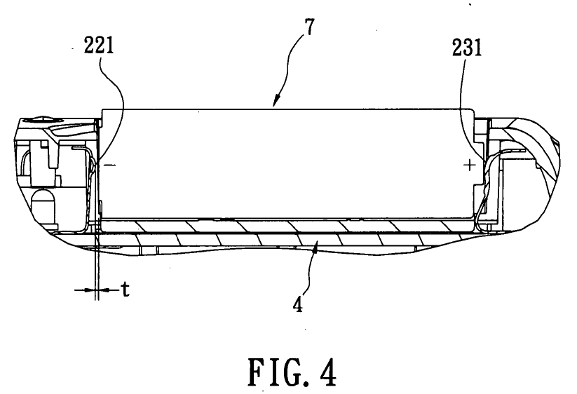

Referring to FIGS. 1-2, a charger 1 of the present invention includes a first housing 2, a second housing 3 and a PCB (printed circuit board) 4. The first housing 2 is defined with two battery chambers 20, 21. Each chamber 20, 21 is assembled with a first resilient plate 22 and a second resilient plate 23 for respectively contacting positive and negative poles of a rechargeable battery. Each resilient plate 22, 23 has a contact portion 221, 231 for contacting the positive/negative pole of the rechargeable battery, and a soldering portion 222, 232 for soldering to the PCB 4. Referring to FIGS. 3-4, the contact portion 221 of the first resilient plate 22 locates at an extending recess (not labeled) in communication with one end of the battery chamber 20. The contact portion 231 of the second resilient plate 23 slightly projects into the other end of the battery chamber 20. The contact portion 221 of the first resilient plate 22 and the extending recess cooperatively define a function of preventing the rechargeable battery 7 from extending into the battery chamber 20 in a wrong direction. Referring to FIG. 4, when the rechargeable battery 7 is received in the battery chamber 20 in a wrong direction, the contact portion 221 of the first resilient plate 22 keeps space t from the negative pole of the battery 7 and so the battery 7 cannot electrically connect to the contact portion 221. FIG. 3 shows that the battery 7 is received in the battery chamber 20 in a right direction and connects the contact portion 221 of the first resilient plate 22.

The second housing 3 is connected with the first housing 2 for forming a whole housing of the charger 1. Two battery chambers 30, 31 are defined in the second housing 3. Each battery chamber 30, 31 is assembled with third and fourth resilient plates 32, 33 for respectively contacting the positive and negative poles of the rechargeable battery 7. The configuration of the third and fourth resilient plates 32, 33 is similar to that of the first and second resilient plates 22, 23.

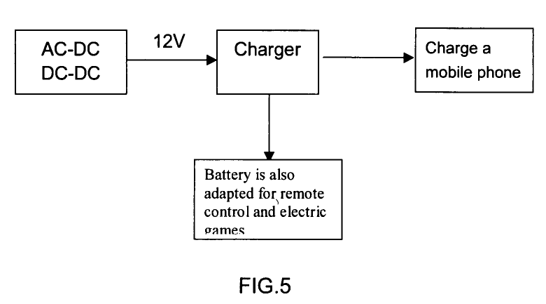

The PCB 4 is assembled between the first and second housings 2, 3. A circuit system (not labeled) is defined at the PCB 4 and includes an AC-DC (alternating current to direct current) circuit, a charging circuit, a voltage booster circuit for controlling voltage boosting of direct current, and a light source indication circuit. The circuits are connected with each other and connected with the soldering portions of the first and second resilient plates of each battery chamber. The circuits are conventional and so not described herein. Furthermore, the circuit system is defined with a power output and input circuit for providing a power input socket 40 connecting to the power output and input circuit to connect with an end of a power wire 5 of which the other end is connected to a car cigarette socket or an indoor socket. Moreover, a power output socket 41 is formed to connect to the power output and input circuit for connecting with an end of a power wire 6 of which the other end is connected to a mobile phone. Further referring to FIGS. 2 and 5, the charger of the present invention can be charged in a car through the external power wire 5, and after the charge is finished, the charger can be directly connected to the mobile phone through the external power wire 6 for power supply or the rechargeable battery 7 can be detached from the charger and then installed in an electrical device such as an electrically operated toy, a remote controller, an electric torch and so on.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A charger, comprising:
a first housing defined with a plurality of battery chambers, each battery chamber being assembled with first and second resilient plates for respectively contacting positive and negative poles of a rechargeable battery, each resilient plate having a contact portion and a soldering portion;
a second housing connected with the first housing;
a PCB assembled between the first and second housing, a circuit system being defined at the PCB and comprising an AC-DC circuit, a charging circuit, and a power output and input circuit, the circuits being connected with each other and connected with the soldering portions of the first and second resilient plates of each battery chamber, a power input socket and a power output socket being formed to connect with the power output and input circuit.

2. The charger as claimed in claim 1, wherein the contact portion of the first resilient plate locates at an extending recess in communication with one end of the battery chamber, the contact portion of the second resilient plate slightly projects into the other end of the battery chamber, and the contact portion of the first resilient plate and the extending recess cooperatively define a function of preventing the rechargeable battery from extending into the battery chamber in a wrong direction.

3. The charger as claimed in claim 2, wherein the power input socket is connectable with an end of a power wire of which the other end is connected to a car cigarette socket or an indoor socket.

4. The charger as claimed in claim 3, wherein the power output socket is connectable with an end of a power wire of which the other end is connected to a mobile phone.

5. The charger as claimed in claim 4, wherein the circuit system further comprises a light source indication circuit driving a light guiding post, and the first housing is defined with a through hole corresponding to the light guiding post.

6. The charger as claimed in claim 5, wherein the second housing is further defined with a plurality of battery chambers, each battery chamber is assembled with third and fourth resilient plates for respectively contacting positive and negative poles of the rechargeable battery, and each resilient plate has a contact portion and a soldering portion.

7. The charger as claimed in claim 6, wherein each of the first and second housings has two battery chambers.

8. The charger as claimed in claim 1, wherein the circuit system further comprises a voltage booster circuit for controlling voltage boosting of direct current.
